(19) United States
(12) Patent Application Publication
(10) Pub. No.: US 2025/0010927 A1
(43) Pub. Date: Jan. 9, 2025

(54) TRACK TENSIONING SYSTEM WITH SLIDING WELDMENT

(71) Applicant: The Charles Machine Works, Inc., Perry, OK (US)

(72) Inventors: Lelan Mack Powers, Stillwater, OK (US); Ryan K. Turner, Stillwater, OK (US)

(21) Appl. No.: 18/766,066

(22) Filed: Jul. 8, 2024

Related U.S. Application Data
(60) Provisional application No. 63/512,444, filed on Jul. 7, 2023.

(51) Int. Cl. B62D 55/30; B62D 55/092; B62D 55/10

(52) U.S. Cl. CPC B62D 55/30; B62D 55/10; B62D 55/092

(57) ABSTRACT

A track frame with a tensioning system. The track frame has a first section, connected to a number of rollers, including a front roller, and a nested second section attached to a rear roller. The orientation of the first and second sections, and thus the tension on a track, is adjusted by a grease cylinder. The track frame has an indicator window, which displays the position of a plate indicative of tension on the track. When the plate is in alignment with the window, tension is appropriate. In addition, the position of the indicator window within a larger window in the first section is indicative of the stroke of the grease cylinder, which may indicate the need to replace the track.

### SUMMARY

The present invention is directed to a track frame. The track frame comprises a first frame structure, a first roller attached to the first frame structure, a second frame structure slidably supported on the first frame structure, a tensioning member, a second roller attached to the second frame structure, and a tension indicator. The tensioning member is disposed between the first frame structure and the second frame structure.

The tension indicator comprises a frame element disposed on the tensioning member, a first window and a second window. The second window is formed in the second frame structure, and the frame element is configured to be visible within the second window. The first window is formed in the first frame structure, wherein the second window is configured to be visible within first window.

The present invention is also directed to a kit. The kit comprises a rubber track, a sprocket, a first frame section, a second frame section, a first roller, a second roller, a cylinder, a coil spring, and an indicator plate. The first frame section has a first window formed therein. The second frame section has a second window disposed therein. The first roller is attached to the first frame section. The second roller is attached to the second frame section. The indicator plate is disposed at an end of the coil spring.

The first frame, second frame, and indicator plate are configurable in a first configuration. The first configuration is defined by the indicator plate being disposed within the second frame section, the second frame section being disposed within the first frame section, and the indicator plate being visible on an outside of the first frame section through the first window and the second window.

The present invention is also directed to a track frame. The track frame comprises a first frame, a second frame, a track, and a tensioning assembly. The second frame is nested within the first frame and slidable relative to the first frame along a longitudinal axis. The track is disposed about the first frame and the second frame. The tensioning assembly is disposed between the first frame and the second frame, and comprises a cylinder and an indicator plate. The cylinder is configured to apply tension between the first frame and the second frame.

The position of the indicator plate relative to the second frame is indicative of a tension provided to the track. The position of the indicator plate relative to the first frame is indicative of a stroke of the cylinder.

### BRIEF DESCRIPTION OF THE DRAWINGS

FIG. 1 is a left side view of a compact skid steer loader having a track assembly with a track tensioning assembly.

FIG. 2 is a left side view of the track assembly, with the elements of the skid loader removed from the view. Hydraulic supply hoses for the motor driving the sprocket are shown extending from the assembly.

FIG. 3 is a top front left perspective view thereof. A cover is shown in place over an access opening through which the grease cylinder is accessible.

FIG. 4 is a left side view with a portion of the track frame removed such that the slider, or tensioning assembly is visible. A grease cylinder is seated within a reaction plate. A zerk and bleed port, accessible with the cover of FIGS. 2-3 removed, are shown in the grease cylinder.

FIG. 5 is a top front left perspective view thereof.

FIG. 6 is a left side view with the track and a portion of the slider, or tensioning assembly, removed. While the plate is removed so that the spring is visible, it should be understood that the plate on the right end of the spring is a part of the tensioning assembly and affixed thereto.

FIG. 7 is a top front left perspective view thereof. FIGS. 6 and 7 do not allow a view of the tensioning indicator window as the frame elements are removed, but the indicator plate and its distance from the various frame elements is, essentially, the tension indicator.

FIG. 8 is a side view of the grease cylinder (attached through the reaction plate element of the track frame) and slider frame (without the rear, movable roller). The indicator window is shown in the correct position, with the indicator plate viewed therethrough.

FIG. 9 is a left front top perspective view thereof.

FIG. 10 is a left sectional view thereof, sectioned through the centerline of the grease zerk and bleed port such that the rod, pilot bar, and spring are visible.

FIG. 11A is a view of the indicator window and frame window, with an indicator plate shown in position indicating the proper tension applied to the track frame by the grease cylinder.

FIG. 11B is the view of FIG. 11A, but with too little tension applied to the track frame by the grease cylinder.

FIG. 12 is a rear top view of the track frame without the track shown. The tensioning assembly is shown nested within the track frame.

FIG. 13 is a side view of a bleeder fitting for use with the grease cylinder of the present invention.

FIG. 14 is a cross-sectional cut-away side view of the grease cylinder with a zerk inserted in a port.

FIG. 15 is a cross-sectional cut-away side view of the greasy cylinder with the bleeder fitting inserted in the bleeder relief port.

### DETAILED DESCRIPTION

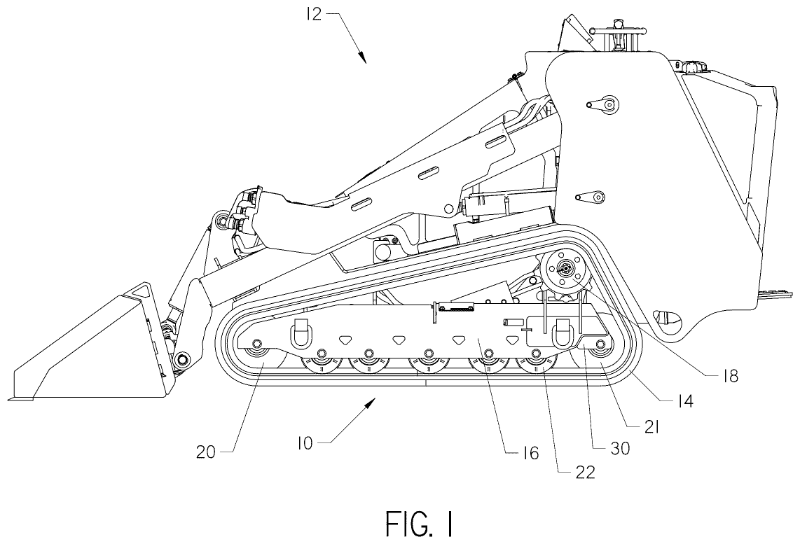

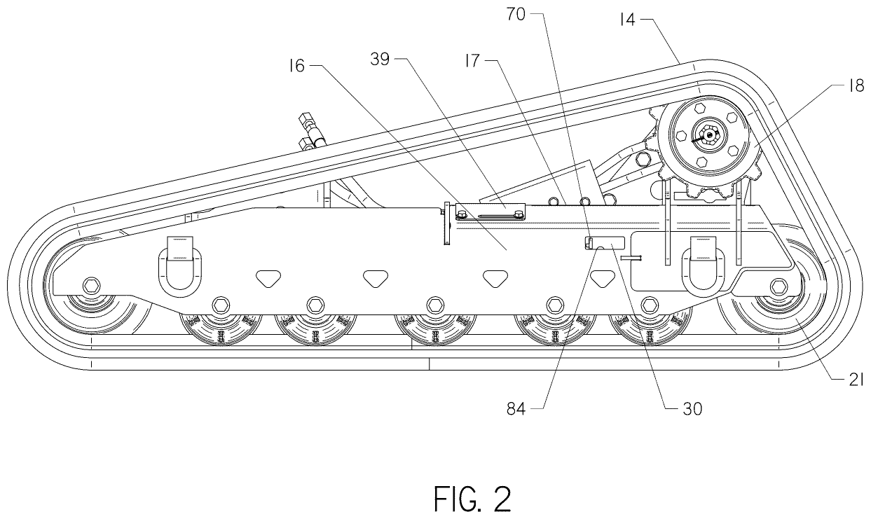

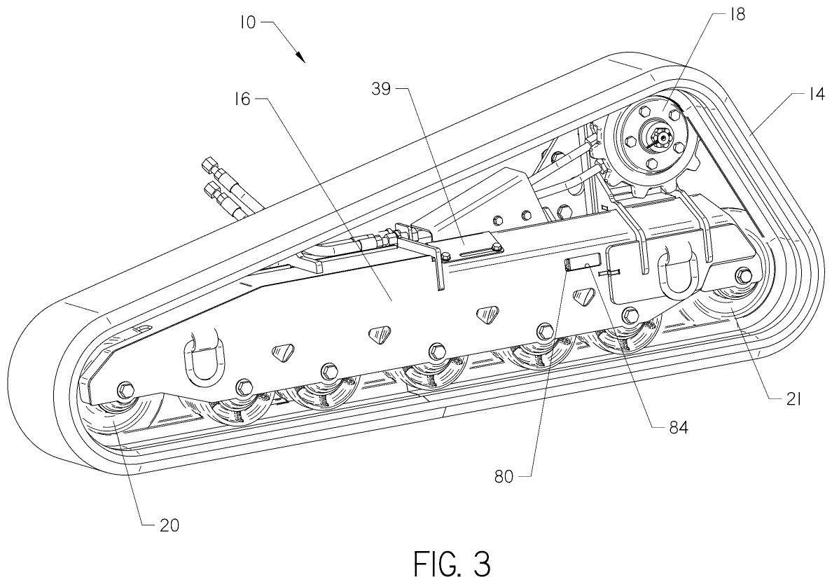

Turning now to the figures, a mechanism for tensioning a track about a track frame is shown. With reference to FIG. 1, track assemblies 10 are often used in compact vehicles 12, as track assemblies provide stability for the vehicle with more contact area with the ground surface than wheels, limiting the surface pressure and increasing traction. The track assembly 10 comprises a track 14 disposed around a track frame 16. The track 14 is driven by a motorized sprocket 18. As shown in FIG. 1, a “triangular” track configuration is used. In a triangular configuration, the track 14 forms a perimeter about the track frame 16, with two large wheels 20, 21 at two apexes of the “triangle”, with the sprocket 18 at the third. A number of bogey rollers 22 are affixed to a bottom side of the track frame 16 and interact with the track 14 proximate the ground surface.

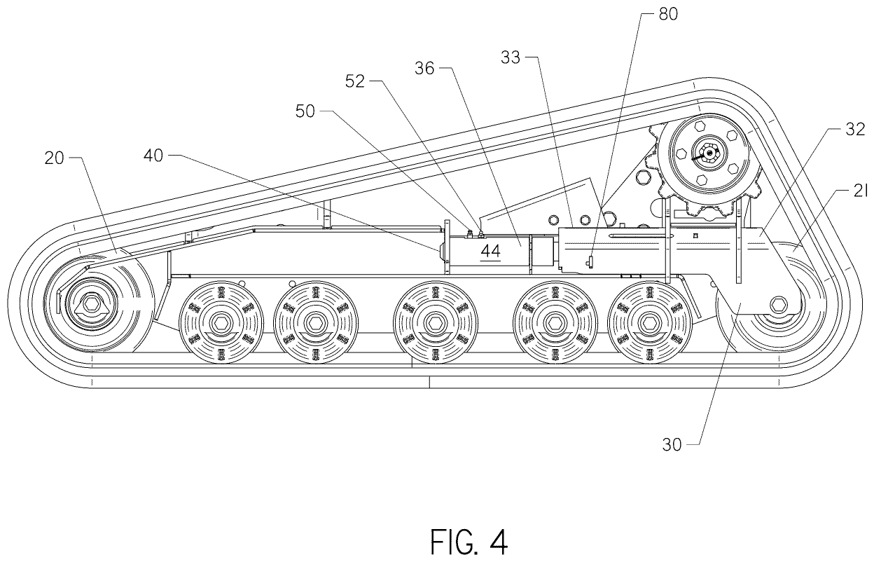

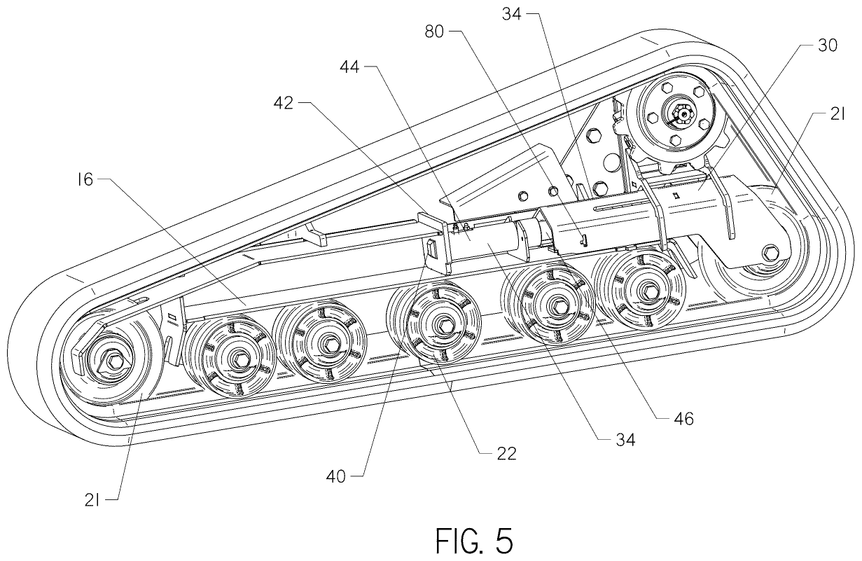

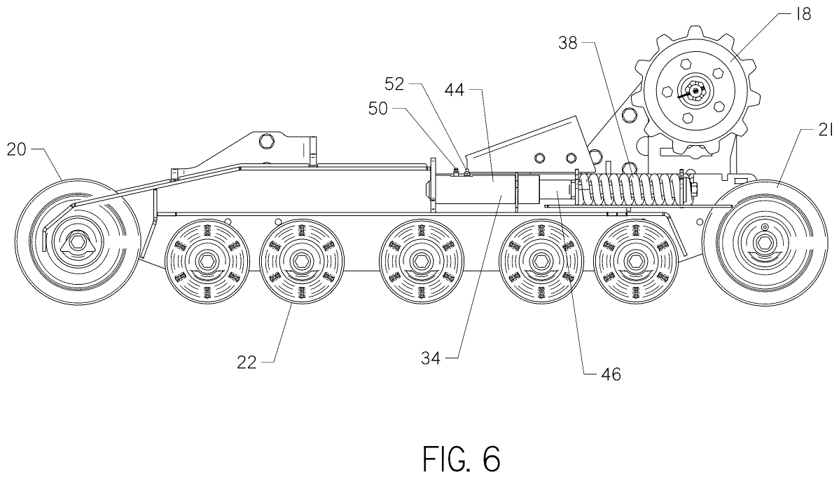

The front wheel 20 is fixed to an axle which is attached to the track frame 16. The rear wheel 21 is attached to a slider, herein described as a tensioning assembly 30, which is slidingly attached to the track frame 16, as will be best shown in FIGS. 4-5. The tensioning assembly 30 allows for the distance between the large front wheel 20 and the large rear wheel 21 to be modified. By shortening the distance, tension is removed from the track 14, allowing it to be removed. By lengthening the distance, the track 14 is tensioned, allowing for operation and, when the track 14 wears, increased life of the track 14 and track assembly 10.

Track tensioning systems that have been used to provide proper tension to a track system include U.S. Pat. No. 10,435,092, issued to Stellman, the contents of which have been incorporated herein by reference. The use of cylinders to adjust tension is also known, as disclosed in U.S. Pat. Pub. No. 2022/0119052, authored by Kukuk, et. al, the contents of which are incorporated by reference. The tensioning assembly shown herein improves on these systems by providing a reliable system for determining both the appropriate tension asserted by the cylinder and a way to determine wear in the track itself.

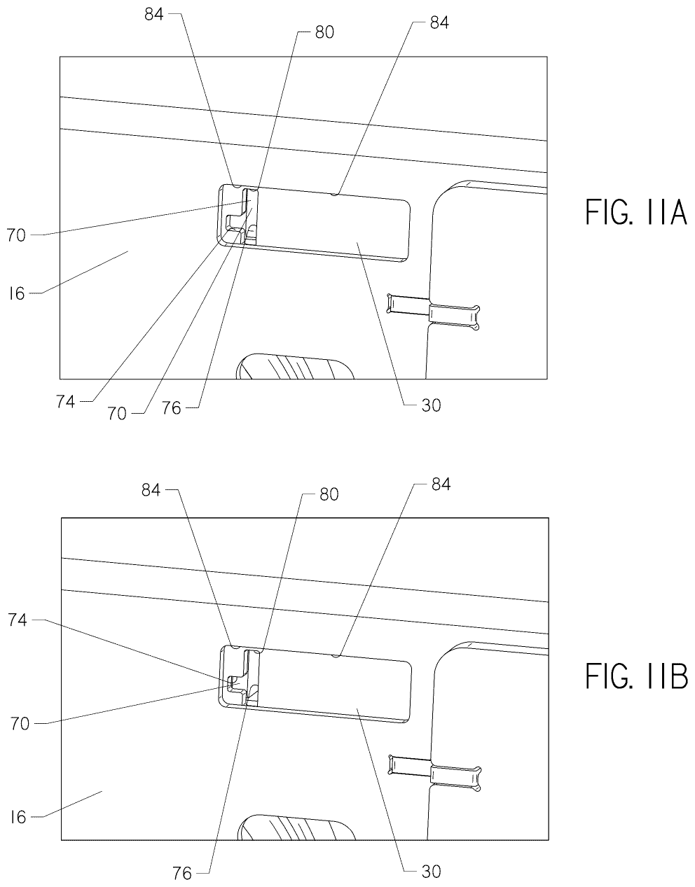

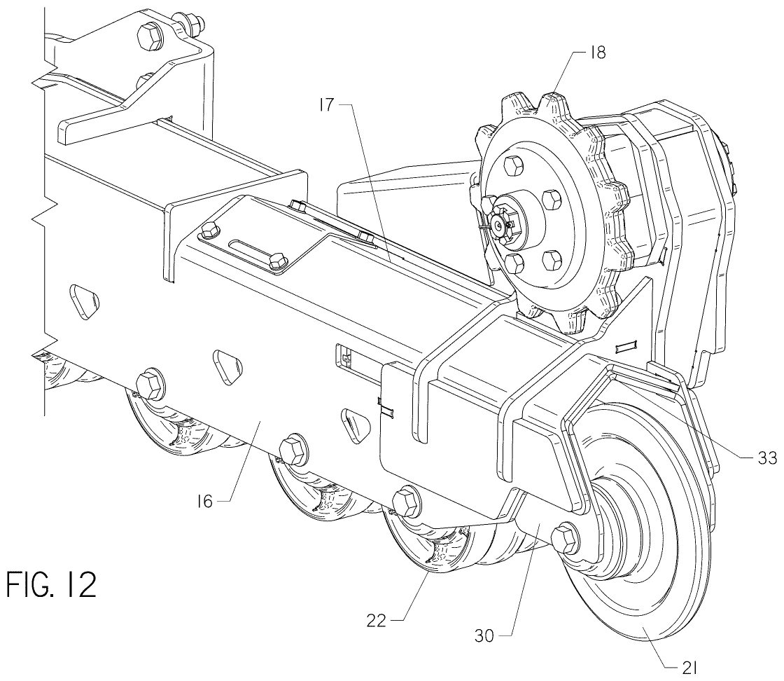

As shown in the Figures, the tensioning assembly 30 comprises a frame portion 32 to which the rear large wheel 21 is attached. The frame portion 32 has a peaked top 33, which is used to key the tensioning assembly 30 to the track frame 16, which includes a similar peaked top 17, within which the tensioning assembly can slide. Preferably, both the peaked tops 33 and 17 have an acute included angle, as best shown in FIG. 12.

The tensioning assembly 30 further comprises a grease cylinder 36, a pilot bar 34, and a coil spring 38. The grease cylinder 36 has a protrusion 40 extending from a first end, which is keyed to an aperture or keyhole 41 on a reaction plate 42. The reaction plate is a frame element of the track frame 16. This interface provides the limit of movement in a first direction (towards the front of the track frame 16).

The grease cylinder 36 has a barrel portion 44 and an extendable rod 46. The grease cylinder 36 has a location where a zerk 50 can be used to increase the grease pressure within the cylinder's barrel 44, thereby extending the rod 46. Additionally, at a separate location, grease may be removed from the cylinder barrel 44 at a relief port or bleed port 52, allowing the rod 46 of the cylinder 36 to retract.

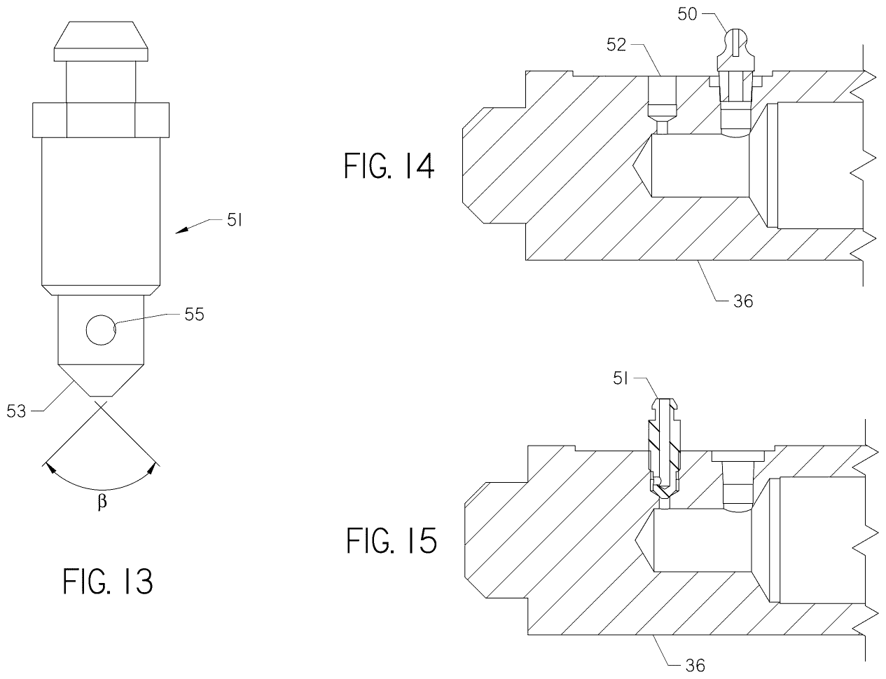

With reference to FIGS. 13-15, the bleed port 52 may have an included angle α at the end of a bore. A bleeder fitting 51 may have a nose 53 with an included angle β. Preferably, β is less than α, as if these angles match, the nose 53 will not properly seat under pressure. The bleeder fitting 51 may thread into the bleeder port 52. When threaded, grease is allowed to exit the barrel section 44 of the cylinder 36 into an annulus around a port 55 in the fitting 51. The bleed port 52 and zerk 50 locations may be accessible under a removable cover 39 placed on the track frame 16, such that these elements of the grease cylinder 36 are accessible without disassembling the track frame 16 or tensioning assembly 30.

Extension and retraction of the rod 46 of the grease cylinder 36 is the primary mechanism by which the distance between the large wheels 20, 21 is extended. When the distance between these points extends, the track 14 is tensioned. When the distance between these points retracts, the track 14 loses tension and can be removed from the track frame 16 and replaced, if desired.

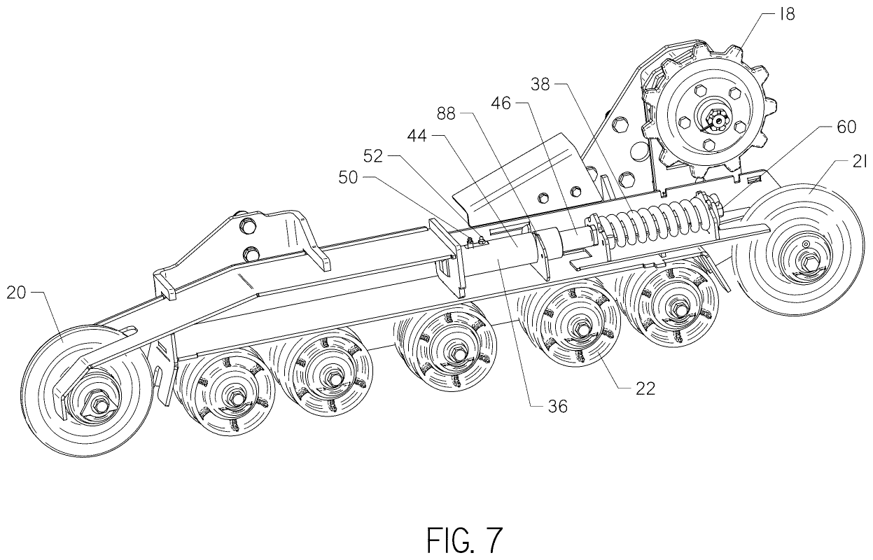

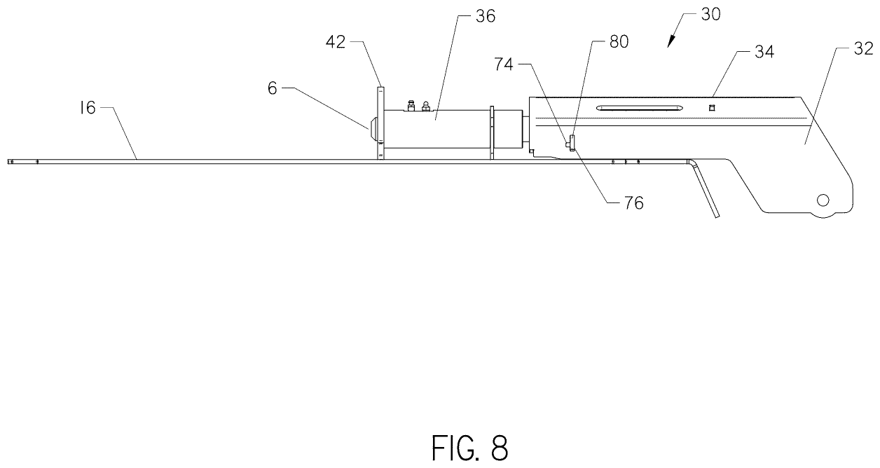

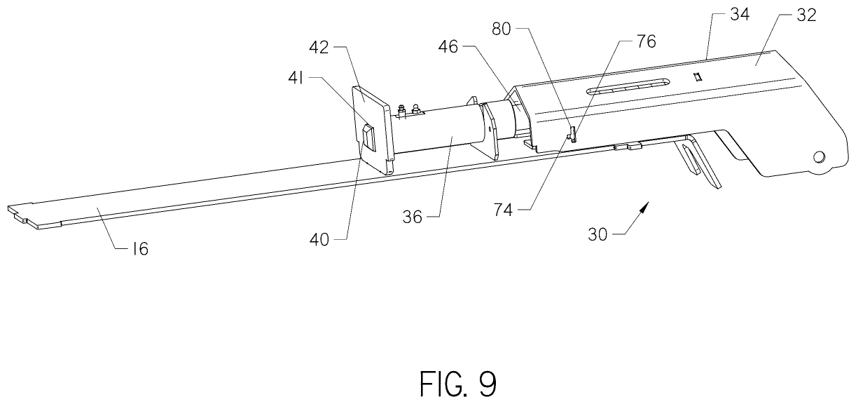

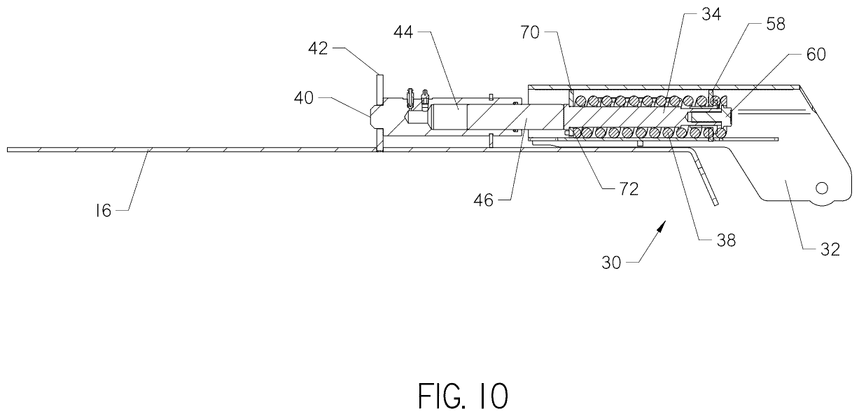

With reference to FIGS. 7-10, the rod 46 of the grease cylinder 36 interacts with the pilot bar 34. The pilot bar 34 is tied to the frame 32 of the tensioning assembly 30 at a first plate 58. A preloading bolt 60 is attached to the pilot bar 34 and grounded against the first plate 58. The coil spring 38 is coiled around the pilot bar 34 and restricted at a first end by the first plate 58. The coil spring 38 extends between the first plate 58 at its first end and an indicator plate 70 at its second end. The second end of the spring 38 abuts the indicator plate 70. The indicator plate 70 surrounds the pilot bar 34 and is disposed between a shoulder 72 of the pilot bar 34 and the spring 38.

The preloading bolt 60 provides an initial preloaded compression to the spring 38. The force caused by this compression causes the indicator plate 70 to rest at a point a known distance away from the first end of the spring 38. The indicator plate 70 is preferably made of a reflective, highly visible material. As the pressure in the grease cylinder 36 increases and the rod 46 extends, the pilot bar 34 is forced towards the first plate 58, causing the sliding frame 32 to move. At the same time, the track 14 on the wheels 20, 21 provides an opposite force, causing the spring 38 to compress.

Thus, the position of the indicator plate 70 relative to the frame of the tensioning assembly 30 is a function of how compressed the spring 38 is. This compression is, itself, an indicator of the amount of force being placed on the movable wheel 21 by the grease cylinder 36. Therefore, the preferred location of the indicator plate 70 relative to the frame of the tensioning assembly 30 is essentially constant.

A first indicator window 80 is formed in the frame 32 of the tensioning assembly 30. The indicator window 80 includes a vertical portion 76, which is substantially the same width as the indicator plate 70. The indicator window 80 also may include a horizontal portion 74, which allows the indicator plate 70 to be visible when the compression of the spring 38 is less (and thus the indicator plate is 70 further towards the front wheel 20 of the track frame 16 than appropriate). As the grease cylinder 36 extends and the spring 38 compresses, the indicator plate 70 moves from the front towards the back wheel 21, moving to the vertical portion 76 of the indicator window 80. The indicator window 80 is placed such that when appropriate tension exists in the coil spring 38 to operate the track frame 16, the indicator plate 70 is visible within the indicator window 80.

In order to be visible to an operator, a frame window 84 is provided within the track frame 16, such that a portion of the frame 32 of the tensioning assembly 30 which includes the indicator window 80 is visible. Thus, when replacing a track 14, an operator can increase pressure within the grease cylinder 36 until the indicator plate 70 is visible within the indicator window 80. Further, the location of the indicator plate 70 can be checked prior to operation, to ensure proper tension exists prior to operating the vehicle 12.

As the track 14 wears and stretches due to continued operation, the rod 46 of the grease cylinder 36 must be extended to maintain the same tension. Therefore, the position of the indicator window 80 itself relative to the track frame 16 indicates the wear of the track system itself. For this reason, the indicator window 80 is visible in the frame window 84. As the indicator window's position within the frame window 84 moves to the back end of the vehicle 12 (that is, toward the wheel 21), an operator should understand that a longer stroke of the grease cylinder 36 is required to maintain the proper tension.

The frame window 84 is preferably sized such that when the indicator window 80 reaches the back end of the frame window, an operator knows that it is time to replace the track 14, because the grease cylinder 36 no longer has the stroke to maintain the proper tension on the tensioning assembly 30. Thus, the position of the indicator plate 70 relative to the frame window 84 is indicative of the stroke of the cylinder 36.

In one embodiment, a large clearance exists in the track frame 16 above the grease cylinder 36. The clearance allows for the addition or removal of grease from the grease cylinder 36, and the manipulation of the cylinder 36 during replacement or refurbishment of the track assembly 10. Preferably, the entire tensioning assembly 30 is held in place within the track frame 16 due only to the forces applied between the reaction plate 42 and the movable large rear wheel 21 when it interacts with the track 14.

Different track frames 16 have different lengths, different numbers of bogie rollers 22, and different geometries. Each of these may have a slightly different required tension such that the track 14 is placed in the preferred tension during operation of the vehicle 12.

In a preferred embodiment, the tensioning assembly 30 for tensioning the track 14 may be consistent with different track assemblies. In order to conform the tensioning assembly 30 to a different track frame 16, a spring 38 having a different spring constant may be used, for example, to maintain the remainder of the elements in the same orientation. In each embodiment, the spring constant of the spring 38 will determine the location of the indicator 70 relative to the indicator window 80.

In operation, an operator may determine that it is time to replace a track 14. This may be done because of observed damage to the track 14, or because the indicator window 80 has reached its rearward limit within the frame window 84. Grease is therefore removed from the grease cylinder 36 at the bleed port 52, and the tensioning assembly frame 32 moves forward within the track frame 16.

The track 14 can be removed from about the sprocket 18 and large wheels 20, 21 when enough length is removed from the track frame 16 due to sliding the tensioning assembly 30 forward. The tensioning assembly frame 32, pilot bar 34, spring 38, and grease cylinder 36 can be removed, inspected, and replaced. The only bolt which would need to be adjusted is the preload bolt 60, if removing the spring 38 and pilot bar 34 is desired.

When assembling the track assembly 10, the protrusion 40 of the grease cylinder 36 is placed within the keyhole 41 in the reaction plate 42. A bracket 88 may be provided to keep the grease cylinder 36 horizontal. The pilot bar 34 is attached to the tensioning assembly frame 32 by the preloading bolt 60. The tensioning assembly 30 is then inserted into the track frame 16 until the pilot bar 34 abuts the rod 46 of the grease cylinder 36.

The track 14 is then placed about the sprocket 18 and other elements of the track frame 16. Grease is added to the grease cylinder 36 through the zerk 50, extending the rod 46. The entire tensioning assembly 30 moves towards the rear of the vehicle 12, pressing against an inside surface of the track 14. As the tensioning assembly 30 extends, the resultant force applied by the track 14 compresses the spring 38, moving the indicator plate 70 to the rear relative to the frame 32 of the tensioner assembly 30. When the indicator plate 70 is visible in the indicator window 80, a proper amount of tension exists in the track frame 16.

In FIG. 11A, the indicator plate 70 is shown through the indicator window 80 in a proper position, with the indicator aligned with the vertical section 76 of the window. Both the indicator plate 70 and indicator window 80 are visible in the frame window 84, indicating that the track 14 has not stretched too much for the tensioning assembly 30 to properly tension.

In FIG. 11B, the track 14 needs more tension, as the indicator plate 70 is shown within the horizontal section 74 of the indicator window 80.

In one embodiment, the spring 38 has a free length of 9.125″, but is preloaded to 8.058″ by the addition of the preloading bolt 60. When grease is applied and the proper tension applied throughout the track frame 16, the spring 38 will compress an additional quarter of an inch. At this point the spring 38 will be compressed at the correct preload of the track 14 with a spring length of 7.808″.

Therefore, in this embodiment, the horizontal section 74 of the indicator window 80 may be a quarter inch, as the “preloaded” length of the spring 38 is only one quarter inch longer than the “properly tensioned” length, the indicator plate 70 will never be more than a quarter inch from the proper position.

The lengths above are provided as examples, and other lengths may be used is without departing from the spirit of the invention. The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A track frame, comprising:
a first frame structure;
a first roller attached to the first frame structure;
a second frame structure, slidably supported on the first frame structure;
a tensioning member, disposed between the first frame structure and the second frame structure;
a second roller attached to the second frame structure; and
a tension indicator, comprising:
a frame element disposed on the tensioning member;
a second window, formed in the second frame structure, wherein the frame element is configured to be visible within the second window; and
a first window, formed in the first frame structure, wherein the second window is configured to be visible within the first window.

2. The track frame of claim 1, wherein the tensioning member comprises:
a cylinder; and
a spring disposed between second frame structure and the frame element.

3. The track frame of claim 2 in which the cylinder comprises a grease cylinder.

4. The track frame of claim 2 in which the track frame is defined by a preferred tension level, and wherein the spring is defined by a spring constant corresponding to the preferred tension level.

5. A track system, comprising:
a track; and
the track frame of claim 1, wherein the track is disposed around the track frame.

6. The track system of claim 5 wherein the track is defined by a preferred track tension, in which the frame element is visible within the second window when the track is placed at the preferred track tension.

7. The track frame of claim 1 in which:
the first frame structure has a first peaked surface, wherein the first peaked surface has a longitudinal ridge; and
the second frame structure has a second peaked surface, wherein the second peaked surface is complimentary to the first peaked surface.

8. The track frame of claim 1 further comprising a plurality of bogey wheels attached to the first frame structure.

9. A kit, comprising:
a rubber track;
a sprocket;
a first frame section having a first window formed therein;
a first roller attached to the first frame section;
a second frame section having a second window disposed therein;
a second roller attached to the second frame section;
a cylinder;
a coil spring; and
an indicator plate disposed at an end of the coil spring;
wherein the first frame, the second frame, and the indicator plate are configurable in a first configuration, wherein the first configuration is defined by:
the indicator plate being disposed within the second frame section;
the second frame section being disposed within the first frame section; and
the indicator plate being visible on an outside of the first frame section through the first window and the second window.

10. The kit of claim 9 wherein:
the cylinder is disposed between the first frame and the second frame; and
the second frame is slidably movable within the first frame.

11. A method of assembling a track frame from the kit of claim 9, comprising:
connecting the second frame to the cylinder;
disposing the coil spring between the second frame and the indicator plate;
connecting the cylinder to the first frame;
sliding the second frame into the first frame;
disposing the rubber track about the sprocket, the first roller and the second roller; and
expanding the cylinder, thereby moving the first roller away from the second roller, until the indicator plate is visible through the second window.

12. The method of claim 11 wherein the cylinder is attached at an end to a pilot bar, the spring being disposed about the pilot bar.

13. The method of claim 11 further comprising:
after disposing the coil spring between the second frame and the indicator plate, preloading the spring using a bolt.

14. The method of claim 11 wherein the step of expanding the cylinder is performed by the steps of:
inserting a zerk into a port in the cylinder; and
providing grease to the cylinder through the zerk.

15. A track frame, comprising:
a first frame;
a second frame, nested within the first frame and slidable relative to the first frame along a longitudinal axis;
a track, disposed about the first frame and the second frame; and
a tensioning assembly, disposed between the first frame and the second frame, and comprises a cylinder configured to applying tension between the first frame and the second frame and an indicator plate;
wherein:
a position of the indicator plate relative to the second frame is indicative of a tension provided to the track; and
a position of the indicator plate relative to the first frame is indicative of a stroke of the cylinder.

16. The track frame of claim 15 wherein the second frame is defined by a second window, wherein the position of the indicator plate relative to the second frame aligns with the second window at a predetermined tension provided to the track.

17. The track frame of claim 15 wherein the first frame is defined by a first window, wherein the position of the indicator plate relative to the first frame aligns with the first window at a predetermined acceptable cylinder stroke.

18. The track frame of claim 17 wherein the second frame is defined by a second window, wherein the position of the indicator plate relative to the second frame aligns with the second window at a predetermined tension provided to the track.
